(19) United States
(12) Patent Application Publication
(10) Pub. No.: US 2014/0344356 A1
(43) Pub. Date: Nov. 20, 2014

(54) SOCIAL NETWORKING SERVICE

(71) Applicant: MOHAMMAD A.H. RAMADHAN, ALROMITHIA (KW)

(72) Inventor: MOHAMMAD A.H. RAMADHAN, ALROMITHIA (KW)

(21) Appl. No.: 13/897,295

(22) Filed: May 17, 2013

(51) Int. Cl. H04L 29/08

(52) U.S. Cl. CPC H04L 67/22
USPC 709/204

(57) ABSTRACT

The social networking service provides a method that offers communication services in which members can communicate and contribute anonymously without knowledge of the originator's identity. Since the social networking service does not accept specific identification from member users, the identification of other target services, such as e-mail, Facebook, Twitter, LinkedIn, phone numbers, and the like, will be used. The service functions as an extension to the external services for providing anonymous collaborative contributions. The social networking service accepts identification from another service and a password, and then attempts to verify the identification by sending verification code to a user identification service. The user becomes a service member once he/she confirms the recipient of the verification code to the service. A service membership is created for users who join the service. Group memberships are created, and predetermined group policies are enforced, while anonymous posting and blogging are allowed.

### BACKGROUND OF THE INVENTION

1. Field of the Invention

The present invention relates to on-line social networking, and particularly to a social networking service that provides anonymity for postings of users of multiple social networking sites.

2. Description of the Related Art

Current social networking services, such as Facebook, Twitter, and other collaborative blogging services, do not allow for anonymous contributions/postings. Memberships in these services are often set up so that members having a shared interest or common relationship can communicate with respect to the shared interest or common relationship. These services would be ideal for brainstorming, whistleblowing and many other uses benefiting from anonymity of postings. However, the services, as currently configured, do not facilitate anonymous posting among members.

Thus, a social networking service solving the aforementioned problems is desired.

### SUMMARY OF THE INVENTION

The social networking service provides a method that offers communication services in which members can communicate and contribute anonymously without knowledge of the originator's identity. Since the social networking service does not accept specific identification from member users, the identification of other target services, such as e-mail, Facebook, Twitter, LinkedIn, phone numbers, and the like, will be used. The service functions as an extension to the external services for providing anonymous collaborative contributions. The social networking service accepts identification from another service and a password, and then attempts to verify the identification by sending verification code to a user identification service. The user becomes a service member once he/she confirms the recipient of the verification code to the service. A service membership is created for users who join the service. Group memberships are created, and predetermined group policies are enforced, while anonymous posting and blogging are allowed.

These and other features of the present invention will become readily apparent upon further review of the following specification and drawings.

### BRIEF DESCRIPTION OF THE DRAWINGS

FIGS. 1A and 1B are block diagrams of a social networking service according to the present invention, showing the relationship of entities involved in connecting a member to the service and showing group services available to the member.

FIG. 2 is a flowchart of the user sign-in process in a social networking service according to the present invention.

Similar reference characters denote corresponding features consistently throughout the attached drawings.

### DETAILED DESCRIPTION OF THE PREFERRED EMBODIMENTS

The social networking service provides a method that offers communication services in which members can communicate and contribute anonymously without knowledge of the originator's identity. Since the social networking service does not accept specific identification from member users, the identification of other target services, such as e-mail, Facebook, Twitter, LinkedIn, phone numbers, and the like, will be used.

The service functions as an extension to the external services for providing anonymous collaborative contributions. The social networking service accepts identification from another service and a password, and then attempts to verify the identification by sending verification code to a user identification service. The user becomes a service member once he/she confirms the recipient of the verification code to the service.

A service membership is created for users who join the service. Group memberships are created, and predetermined group policies are enforced, while anonymous posting and blogging are allowed. For each group member, a single password can be associated with multiple ID's (from different social networking services combined in one service member account), as chosen by the group member.

The service method forms a layer to other services. Group operations and voting mechanisms provided by the social networking service are expected to generate most of the traffic to a website supporting the service. Main uses of the service include brainstorming and whistle blowing, or many other uses benefiting from the anonymity of postings.

The group membership represents a shared interest or relation between members. The social networking service maintains the group as an entity, which can be subscribed to (or followed).

The service is run using an application server and a web server, which physically could be installed on a single computer, on networked computers in a distributed OS environment, or as Software as a Service (SAAS) running in a cloud environment, and the like. The service could be offered online through the Internet and through different applications on different devices and operating systems, such as Android, IOS, etc., all communicating with the application server and web server via the Internet. Method steps of the social networking service could be embodied in a computer software product, comprising a non-transitory medium readable by a processor, the non-transitory medium having stored thereon a set of instructions which execute the method steps of the social networking service.

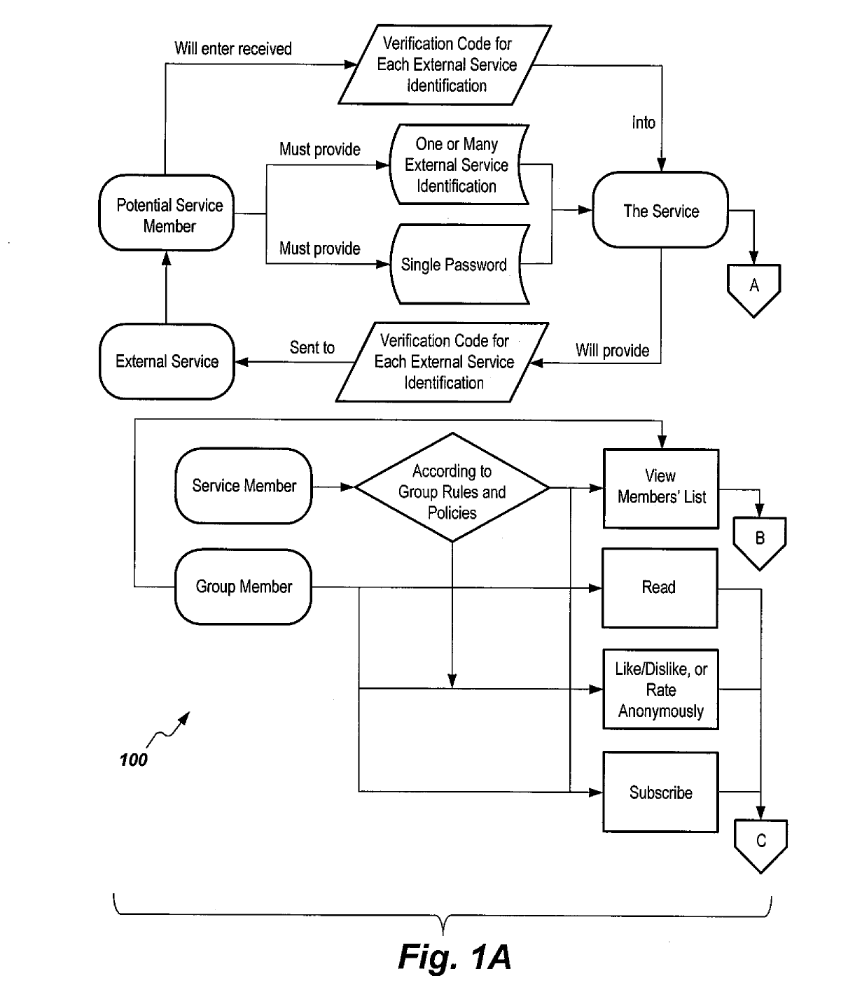

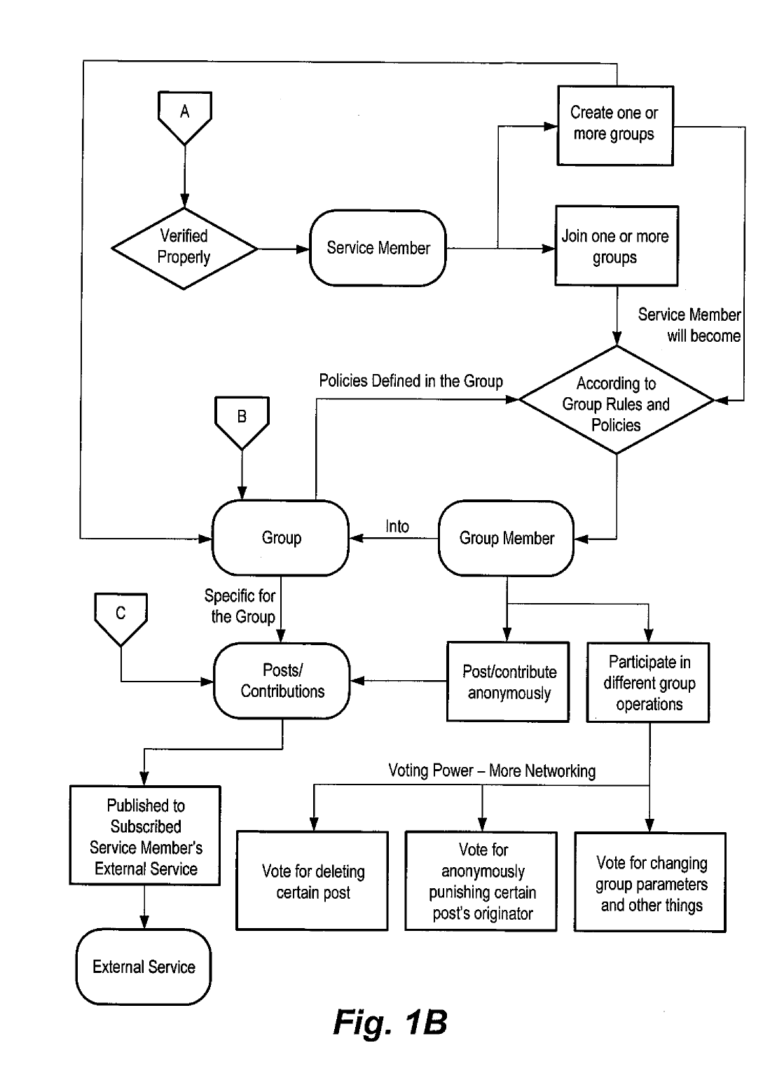

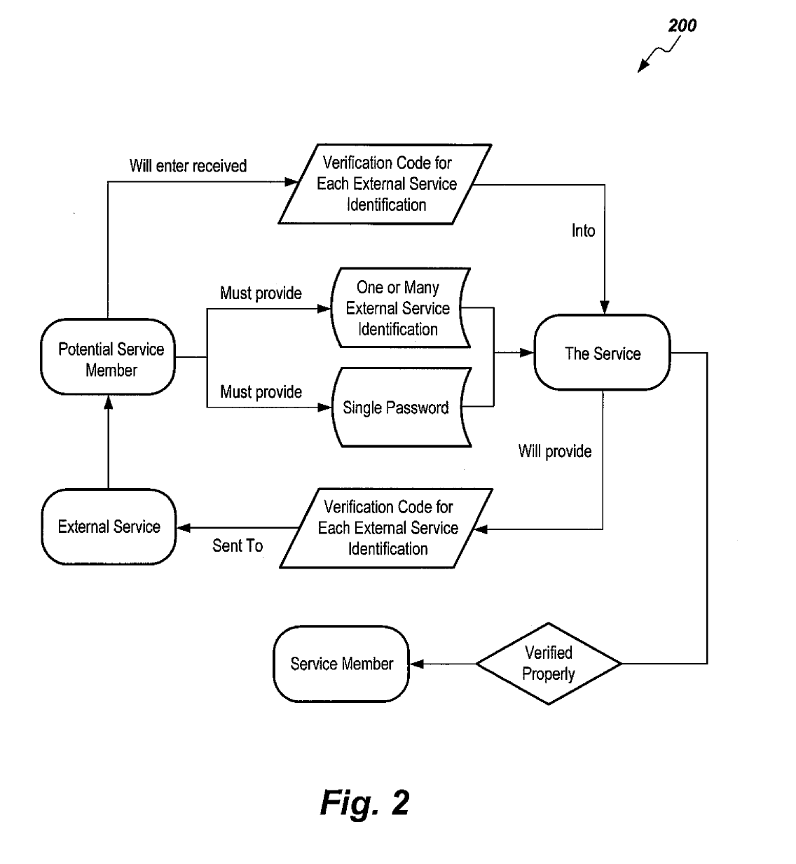

As shown in FIGS. 1A-1B, the basic design 100 requires that the social networking service compel a user to provide a single password, since it accepts specification of one or many external service IDs from the user. Details of the user sign-in process 200 are shown in the process flow diagram illustrated in FIG. 2. The software requires a member to have a unique identity, which could be an e-mail address; another social network profile or identity such as Facebook, Twitter, LinkedIn and others; or an international telephone number. Moreover, the software requires the user to provide a password conforming to password rules of the service (the password can be changed later by the service member). And lastly, the software requires entry of a verification of identity provided (through sending verification code or any other verification mechanism).

The social networking service then sends a verification code (VC) for each external service identification to the external service, which forwards the code back to the service member. The user then enters the VCs into an interface provided by the service. If the service verifies proper user credentials in the VCs, the service officially designates the user as a “Service Member,” and the application software provides the Service Member with an interface in which the Service Member may create one or more groups or join one or more groups. Once several service members join a group and become group members, they are expected collectively to take decisions for the group. The group member can decide to leave the group at any time by requesting that from the service. A certain number of group members may vote on removing a group member from the group, and the service accepts their request if their numbers meet the necessary number defined in the group parameters.

The application software of the social networking service enforces the aforementioned parameters via group rules and policies in the event that the Service Member is attempting to join a group. The application software denies the group join attempt if the Service Member's profile does not comport with the rules and policies of the group.

Once the Service Member has successfully joined or created a group, the application software of the social networking service provides an interface wherein the Service Member (as a member of the group) can post/contribute anonymous communications to the group. A publication engine of the social networking service publishes the posts/contributions anonymously to the Service Member's external service, such as Facebook, Google+, LinkedIn, and the like.

From the perspective of the external service, the group members can see the post. The post adheres to group rules and policies. The group members know that the post was from a member, but they do not know specifically who caused the post to be published to the group.

Additionally, the software provides a group operations interface in which the software processes votes for changing group parameters, votes for anonymously punishing originators of other posts, votes for deleting selected posts, and the like. Any posting or contribution is posted to the group and is anonymous in terms of its originator identity. So any group member could see the group postings without knowing the identity of the originator. The postings or contributions could be in text or any other digital media formats that can be transferred through the Internet, such as pictures, documents, and the like.

Any group member who has the post privilege will be able to post to the group. The postings will not have the identity of the originator attached and by no way could any group member (except the originator) know the identity of the originator. The originator identity shall remain anonymous. Even the originator cannot show (through the service) any verification that he/she has posted that posting.

Postings are not to be deleted by the service unless group members choose to do so in a collaborative decision. Postings will be shown by the service with timestamp and other information, such as the number of likes and dislikes, but without its originator identity. Any posting that group members believe is out of order or is annoying, a certain number of group members can vote to delete it (as per the group rules), and it will be deleted by the service.

A certain number of group members can vote that any posting is out of order (before deleting it) and that the originator should be punished by the service and not allowed to post (for this group) for a certain period (defined by group rules—member punishments) anonymously without the ability to be verified by any member directly by the service

The application software of the social networking service allows a Service Member who has joined a group to view the members' list, read the members' posts, anonymously like/dislike or rate the members' posts, and subscribe to services offered by the group.

It is to be understood that the present invention is not limited to the embodiments described above, but encompasses any and all embodiments within the scope of the following claims.

I claim:

1. A computerized social networking service method, comprising the steps of:
a web server providing an input field allowing a user to log into the service;
an application server in combination with the web server collecting from the user identification information of the user with respect to remote target social networking services;
the application server in combination with the web server verifying the user identification information;
the application server in combination with the web server creating a service membership for the user based on successful verification of the user identification information;
the application server in combination with the web server joining the user to at least one group membership responsive to user entry requesting to join a group existing in at least one of the remote target social networking services; and
the application server in combination with the web server anonymously publishing posts from the user, the posts being published to the group of the at least one of the remote target social networking services.

2. The social networking service according to claim I, further comprising the step of said application server in combination with said web server creating a service membership profile associated with said user.

3. The social networking service according to claim 2, further comprising the step of said application server in combination with said web server enforcing group rules and policies of said group to determine whether to allow said user to join said group.

4. The social networking service according to claim 3, further comprising the step of said application server in combination with said web server comparing parameters of said group rules and policies against attributes stored in said user's service membership profile to accept, and alternatively to deny said user membership in said group.

5. The social networking service according to claim 4, further comprising the steps of:
said application server in combination with said web server creating at least one new group responsive to user entry requesting to create said at least one new group; and
said application server promulgating said at least one new group in at least one of said remote target social networking services.

6. The social networking service according to claim 5, further comprising the step of said application server in combination with said web server enforcing a collective policy in which through voting, a plurality of group members collectively make decisions for said group.

7. The social networking service according to claim 6, further comprising the steps of:
said application server in combination with said web server providing a group operations interface in which software application of said application server processes votes for changing parameters of said group;
said application server processing votes for anonymously punishing originators of posts objected to by said plurality of group members; and
said application server processing votes for deleting selected said posts.

8. The social networking service according to claim 7, further comprising the step of said application server in combination with said web server defining a voting quorum in accordance with a number defined in said parameters stored for said group.

9. The social networking service according to claim 8, further comprising the step of said application server in combination with said web server publishing said posts in a digital media format including any combination of text, photos, and videos.

10. The social networking service according to claim 9, further comprising the step of said application server in combination with said web server anonymously deleting said posts selected for deletion according to said application server processing of said votes for deletion.

11. The social networking service according to claim 10, further comprising the steps of:
said application server in combination with said web server allowing a service member who has joined said group to view a members' list;
said application server in combination with said web server allowing said service member to read members' posts;
said application server in combination with said web server allowing said service member to anonymously like/dislike members' posts;
said application server in combination with said web server allowing said service member to rate members; posts; and
said application server in combination with said web server allowing said service member to subscribe to services offered by said group.

12. A computer software product, comprising a medium readable by a processor, the medium having stored thereon a set of instructions for offering a social networking service, the set of instructions including:
(a) a first sequence of instructions which, when executed by the processor, causes said processor to provide an input field allowing a user to log into the service;
(b) a second sequence of instructions which, when executed by the processor, causes said processor to collect from said user identification information of said user with respect to remote target social networking services;
(c) a third sequence of instructions which, when executed by the processor, causes said processor to verify said user identification information;
(d) a fourth sequence of instructions which, when executed by the processor, causes said processor to create a service membership for said user based on successful verification of said user identification information;
(e) a fifth sequence of instructions which, when executed by the processor, causes said processor to join said user to at least one group membership responsive to user entry requesting to join a group existing in at least one of said remote target social networking services; and
(f) a sixth sequence of instructions which, when executed by the processor, causes said processor to anonymously publish posts from said user, said posts being published to said group of said at least one of said remote target social networking services.

13. The computer software product according to claim 12, further comprising a seventh sequence of instructions which, when executed by the processor, causes said processor to create a service membership profile associated with said user.

14. The computer software product according to claim 13, further comprising an eighth sequence of instructions which, when executed by the processor, causes said processor to enforce group rules and policies of said group to determine whether to allow said user to join said group.

15. The computer software product according to claim 14, further comprising a ninth sequence of instructions which, when executed by the processor, causes said processor to compare parameters of said group rules and policies against attributes stored in said user's service membership profile to accept, and alternatively to deny said user membership in said group.

16. The computer software product according to claim 15, further comprising:
a tenth sequence of instructions which, when executed by the processor, causes said processor to create at least one new group responsive to user entry requesting to create said at least one new group; and
an eleventh sequence of instructions which, when executed by the processor, causes said processor to promulgate said at least one new group in at least one of said remote target social networking services.

17. The computer software product according to claim 16, further comprising:
a twelfth sequence of instructions which, when executed by the processor, causes said processor to enforce a collective policy in which via voting, a plurality of group members collectively make decisions for said group.

18. The computer software product according to claim 17, further comprising:
a thirteenth sequence of instructions which, when executed by the processor, causes said processor to provide a group operations interface in which software application of said application server processes votes for changing parameters of said group;
a fourteenth sequence of instructions which, when executed by the processor, causes said processor to process votes for anonymously punishing originators of posts objected to by said plurality of group members; and
a fifteenth sequence of instructions which, when executed by the processor, causes said processor to process votes for deleting selected said posts.

19. The computer software product according to claim 18, further comprising a sixteenth sequence of instructions which, when executed by the processor, causes said processor to defining a voting quorum in accordance with a number specified in said parameters stored for said group.

20. The computer software product according to claim 19, further comprising:
a seventeenth sequence of instructions which, when executed by the processor, causes said processor to allow a service member who has joined said group to view a members' list;
an eighteenth sequence of instructions which, when executed by the processor, causes said processor to allow said service member to read members' posts;
a nineteenth sequence of instructions which, when executed by the processor, causes said processor to allow said service member to anonymously like/dislike members' posts;
a twentieth sequence of instructions which, when executed by the processor, causes said processor to allow said service member to rate members' posts; and
to a twenty-first sequence of instructions which, when executed by the processor, causes said processor to allow said service member to subscribe to services offered by said group.
